(19) United States
(12) Patent Application Publication
(10) Pub. No.: US 2015/0095465 A1
(43) Pub. Date: Apr. 2, 2015

(54) METHOD FOR SETTING SYSTEM CONFIGURATION OF A COMPUTER CONNECTED WITH A ONE-TO-MANY WIRELESS DEVICE GROUP DURING BOOTING OF THE COMPUTER

(71) Applicant: Syncomm Technology Corporation, Hsinchu City (TW)

(72) Inventor: Jung-Hsin YEH, Hsinchu City (TW)

(73) Assignee: Syncomm Technology Corporation, Hsinchu City (TW)

(21) Appl. No.: 14/039,270

(22) Filed: Sep. 27, 2013

(51) Int. Cl. H04L 12/24

(52) U.S. Cl. CPC H04L 41/0803
USPC 709/220

(57) ABSTRACT

A method for setting system configuration of a computer connected with a one-to-many wireless device group during booting of the computer is provided. The wireless device group includes a wireless connector electrically connected to the computer and a wireless input device and a wireless audio device: The method of the invention comprises the steps of: setting the wireless connector in a first state to form wireless connection with the wireless input device; performing system configuration setup by a user through the wireless input device after the computer has loaded a Basic Input/Output System to perform Power-On Self Test and judge that the first state conforms to a test threshold; and triggering the wireless connector to switch to a second state of forming wireless connection with the wireless input device and wireless audio device so that the computer can transmit audio data to the wireless audio device through the wireless connector.

### FIELD OF THE INVENTION

The present invention relates to a method and particularly to a method for setting system configuration of a computer connected with a one-to-many wireless device group during booting of the computer.

### BACKGROUND OF THE INVENTION

With the development of wireless communication technology, more and more consumer electronic products and electric appliances are supported with wireless connection technique to overcoming the constraints of distance and space to improve the convenience and usability, such as wireless microphone, wireless earphone, wireless mouse, wireless keyboard, wireless stereo, wireless joystick and the like.

In the earlier days wireless audio transmission devices, such as wireless earphone, adopted infrared or Bluetooth transmission technique. They are deficient in efficacy and have constraints in development. Later on, development of 2.4G wireless technology makes the communication transmission has features such like excellent robust interference avoidance capability, transmission distance can reach ten meters and transmission speed can attain 2 MB per second. As a result, wireless audio transmission market once again becomes a heavy focus among many producers.

U.S. publication No. 20050273187 discloses a multi-audio-source wireless transmission system. It comprises a Universal Serial Bus (USB) connector which forming electric connection with a notebook computer, a wireless emission module and a wireless receiving module that forming wireless connection with the wireless emission module, and the wireless emission module is connected with the USB connector. The wireless receiving module is installed on an audio device. Thus the notebook computer can play or receive audio signals in a wireless fashion through the audio device via the wireless emission module and wireless receiving module.

However, for the general desktop computer, forming wireless connection concurrently with a wireless keyboard, a wireless mouse and a wireless audio device often requires at least two USB connectors, one of the sharing USB connector allows the wireless keyboard and wireless mouse establish wireless link with the desktop computer, and another USB connector makes the wireless audio device establish wireless link with the desktop computer.

As a result, the number of USB ports on the desktop computer could become insufficient with increasing number of wireless devices to be connected. To overcome this limitation a technique to integrate wireless connection between the USB connector and multiple computer wireless peripherals has been developed, such as a one-to-many USB connector capable of forming wireless connection with a keyboard, a mouse and an audio device at the same time. But it creates another problem when adopted on a desktop computer, i.e. the desktop computer cannot recognize the one-to-many USB connector during booting process. This makes the keyboard connected to the one-to-many USB connector useless and results in unable to perform system configuration setup of the desktop computer during the booting stage.

### SUMMARY OF THE INVENTION

The primary object of the present invention is to solve the problem of unable setting system configuration during the desktop computer booting process. The problem occurs when a USB connector of desktop computer is connected to a wireless keyboard, a wireless mouse and a wireless audio device at the same time.

To achieve the foregoing object, the invention provides a method for setting system configuration of a computer connected with a one-to-many wireless device group during booting of the computer. The wireless device group includes a wireless connector electrically connected to the computer, and a wireless input device and a wireless audio device both connected to the wireless connector in a wireless fashion. The method comprises the steps as follow:

Step 1. computer is powered on by a user to execute a booting process while the wireless connector is in a first state of forming wireless connection with the wireless input device but not forming wireless connection with the wireless audio device;

Step 2: The computer loads a Basic Input/Output System (BIOS) to perform a Power-On Self Test (POST) during the booting process;

Step 3: The BIOS in the POST judges that the first state of the wireless connector conforms to a test threshold to allow the user to perform system configuration setup in the BIOS of the computer through the wireless input device;

Step 4: The computer continues the booting process after the system configuration setup is finished; and

Step 5: The wireless connector is triggered to switch from the first state to a second state in which the wireless connector forms wireless connection concurrently with the wireless input device and wireless audio device such that the computer is allowed to transmit audio data to the wireless audio device through the wireless connector.

Thus, by switching from the first state in which the wireless connector forms wireless connection merely with the wireless input device to the second state in which the wireless connector forms wireless connection with both the wireless input device and wireless audio device at the same time, the user can set system configuration of the computer in the BIOS via the wireless input device during the booting process of the computer. Therefore, this method improves the convenience and usability of the wireless device group.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a process flowchart of an embodiment of the invention.

FIG. 2A is a schematic view of the wireless connector in a first state of an embodiment of the invention.

FIG. 2B is a schematic view of the wireless connector in a second state of an embodiment of the invention.

### DETAILED DESCRIPTION OF THE PREFERRED EMBODIMENT

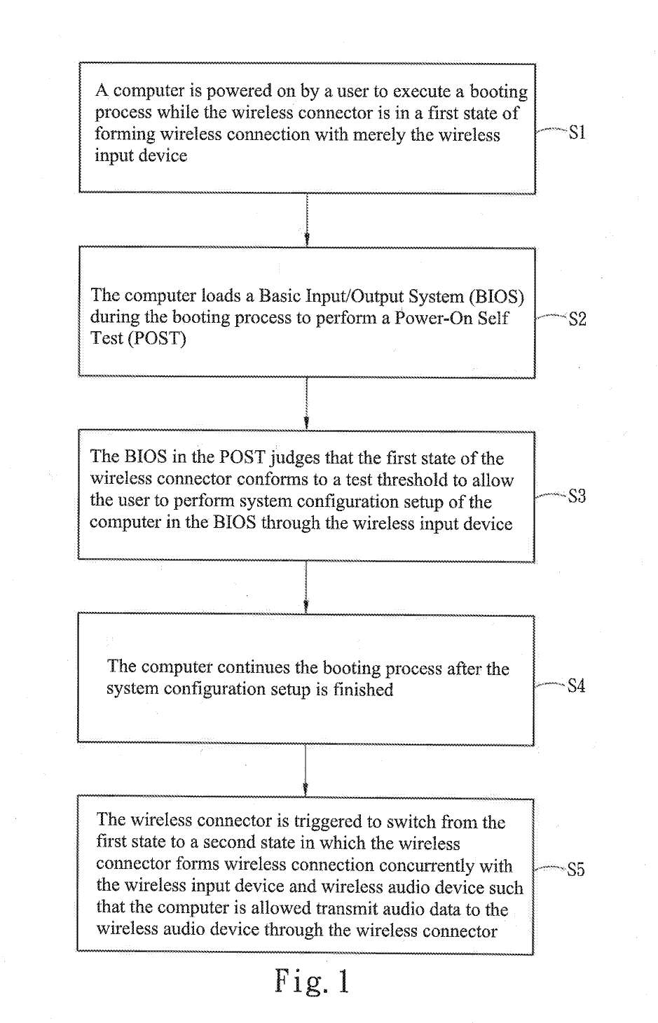

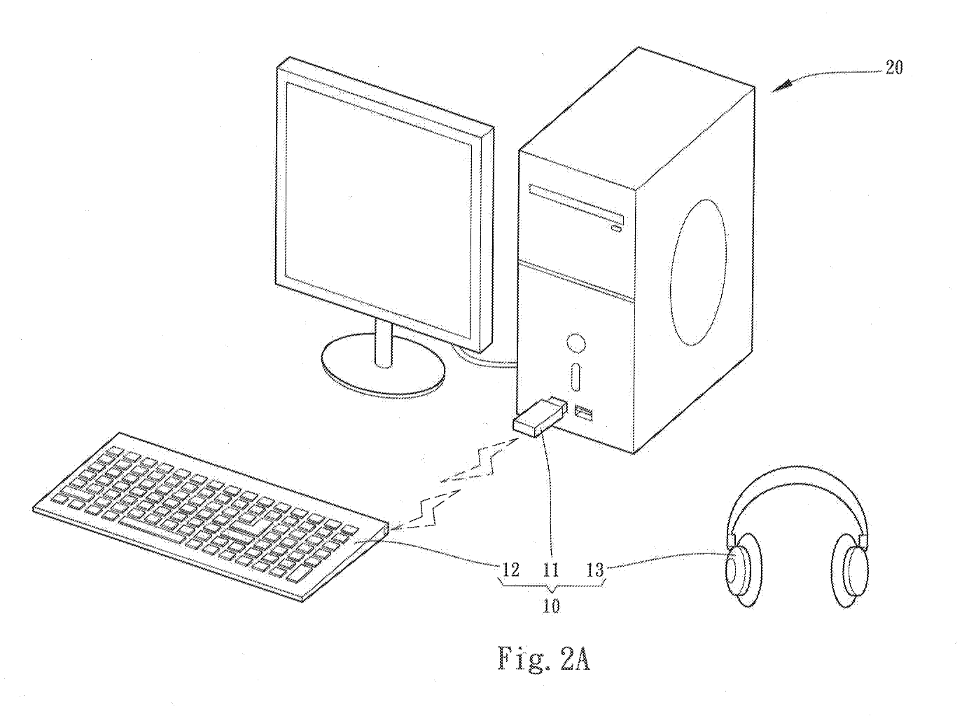

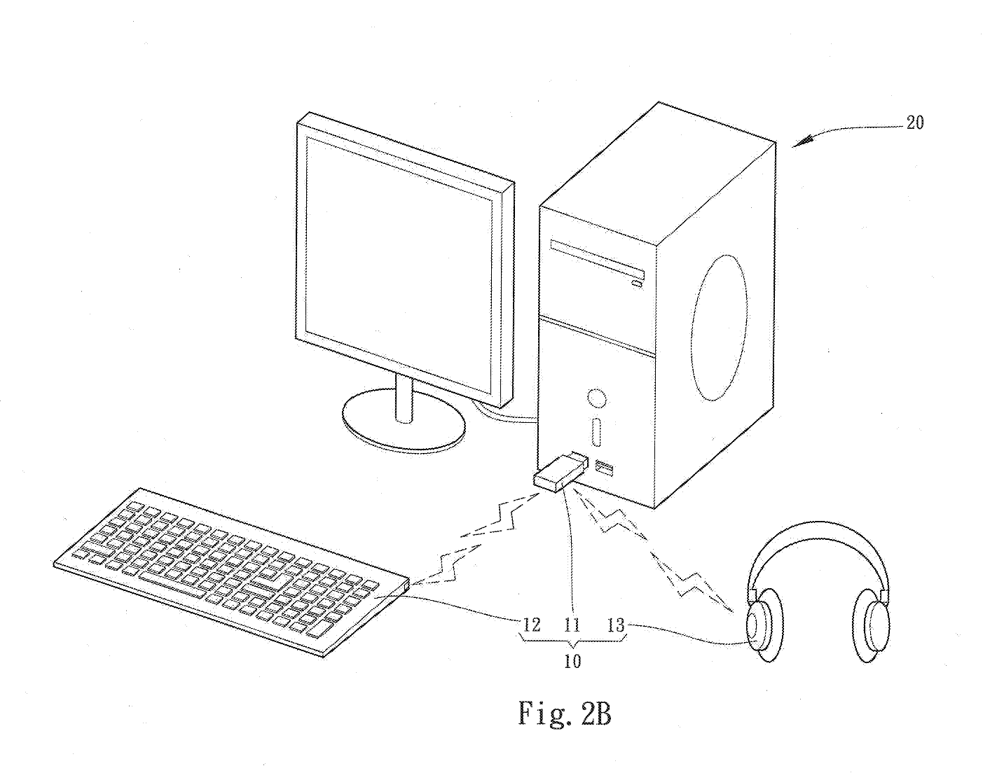

Please referring to FIGS. 1, 2A and 2B, the invention aims to provide a method for setting system configuration of a computer connected with a one-to-many wireless device group during booting of the computer. (FIG. 2B)The wireless device group 10 includes a Wireless connector 11, a wireless input device 12 and a wireless audio device 13. The wireless connector 11 is electrically connected to a computer 20 through a USB. The computer 20 is a desktop computer in this embodiment to serve as an example, but not the limitation. The computer 20 also can be other types of electronic processors such as laptop computer, industrial computer or embedded system. The wireless input device 12 and wireless audio device 13 are connected to the wireless connector 11 in a wireless fashion. In this embodiment the wireless input device 12 is a wireless keyboard, but not the limitation. It also can be a mouse, remote controller or the like. The wireless audio device 13 can be a wireless earphone, wireless speaker, wireless microphone or the like. The method comprises the steps as follow:

Step 1(S1): Referring to FIG. 2A, the computer 20 is powered on by a user to execute a booting process while the wireless connector 11 is in a first state by forming wireless connection with the wireless input device 12 but not yet forming wireless connection with the wireless audio device 13. The wireless connection uses an Industry Science and Medical (ISM) frequency band, which commonly ranged from 2.4 GHz to 2.4835 GHz, but not the limitation. More specifically, in the first state the wireless connector 11 has a first USB descriptor identified by the computer 20 to allow the computer 20 to recognize the wireless connector 11 forms wireless connection merely with the wireless input device 12;

Step 2(S2): The computer 20 loads a Basic Input/Output System (BIOS) during the booting process to perform a Power-On Self Test (POST) to inspect the current status of all internal storage and hardware equipments.

Step 3(S3): The BIOS inspects the first USB descriptor of the wireless connector 11 in the POST and is noticed that in the first state of the wireless connector 11 forms wireless connection merely with the wireless input device 12, and judges that the first state conforms to a test threshold. Therefore the BIOS can recognize the wireless input device 12 and allow the user to perform system configuration setup on a setup interface in the BIOS of the computer 20 through the wireless input device 12. The system configuration setup can include Standard CMOS Setup, BIOS Features Setup, Chipset Features Setup and the like. As a result, the user can perform system configuration setup of the computer 20 according to requirements.

Step 4(S4): The computer 20 continues the booting process after the system configuration setup is finished. In this embodiment, the computer 20 is rebooted to finish the system configuration setup and continues the booting process after the system configuration setup is done.

Step 5(S5): Referring to FIG. 2B, the wireless connector 11 is triggered to switch from the first state to a second state in which the wireless input device 11 changes the potential of signal lines in the USB to make the computer 20 deem that the wireless connector 11 is unplugged, then returns to the original potential. Since the computer 20 deems that the wireless connector 11 has been unplugged, it will reconnect to the wireless connector 11 through the USB connector and perform enumeration to the wireless connector 11 again. At that time the wireless connector 11 in the second state forms wireless connection concurrently with the wireless input device 12 and wireless audio device 13, and the wireless connector 11 has a second USB descriptor to allow the computer 20 to recognize wireless connection among the wireless connector 11 and the wireless input 12 and wireless audio device 13. It is to be noted that in this embodiment trigger of the wireless connector 11 can be done in two approaches:

The first approach, the user activates the wireless audio device 13 to make the wireless audio device 13 send an activation signal to the wireless connector 11; the wireless connector 11 receives the activation signal to switch from the first state to the second state.

The second approach, the computer 20 loads an operation system during the booting process. The operation system can be WINDOWS system, MAC system or LINUX system or the like. The operation system executes an application program related to the wireless connector 11 to trigger the wireless connector 11 to switch from the first state to the second state.

When the wireless connector 11 is in the second state, the computer 20 can recognize the wireless connector 11 has been forming a connection with the wireless input device 12 and wireless audio device 13 via the second USB descriptor, and treats the wireless connector 11 as a full function hybrid device. Therefore, the computer 20 can transmit audio data to the wireless audio device 13 through the wireless connector 11. For instance, the user can listen to music played by the computer 20 through the wireless earphone, and at the same time the computer 20 can also be operated via the wireless input device 12.

As a conclusion, by switching from the first state in which the wireless connector forms wireless connection merely with the wireless input device to the second state in which the wireless connection are formed with both the wireless input device and wireless audio device, user can set system configuration of the computer in the BIOS via the wireless input device during the booting process of the computer, which improves the convenience and usability of the wireless device group. Moreover, the user can select the wireless audio device or application program to trigger the wireless connector to switch from the first state to the second state according to requirements to further improve usability. It provides significant improvement over the conventional techniques.

While the preferred embodiment of the invention has been set forth for the purpose of disclosure, it is not the limitation of the invention, modifications of the disclosed embodiment of the invention as well as other embodiments thereof may occur to those skilled in the art. Accordingly, the appended claims are intended to cover all embodiments which do not depart from the spirit and scope of the invention.

What is claimed is:

1. A method for setting system configuration of a computer connected with a one-to-many wireless device group during booting of the computer, the wireless device group including a wireless connector electrically connected to the computer and a wireless input device and a wireless audio device both connected to the wireless connector in a wireless fashion, the method comprising the steps of:
step 1: setting power-on of the computer by a user to execute a booting process while the wireless connector is in a first state of forming wireless connection with merely the wireless input device but not forming wireless connection with the wireless audio device;
step 2: loading a Basic Input/Output System in the computer to perform a Power-On Self Test during the booting process;
step 3: judging by the Basic Input/Output System in the Power-On Self Test that the first state of the wireless connector conforms to a test threshold to allow the user to perform system configuration setup of the computer in the Basic Input/Output System through the wireless input device;
step 4: continuing the booting process of the computer after the system configuration setup is finished; and
step 5: triggering the wireless connector to switch from the first state to a second state in which the wireless connector forms wireless connection concurrently with the wireless input device and the wireless audio device such that the computer is allowed to transmit audio data to the wireless audio device through the wireless connector.

2. The method of claim 1, wherein the Basic Input/Output System judges that the first state of the wireless connector confirms to the test threshold in the Power-On Self Test at the step 3 by recognizing that the wireless connector is merely connected with the wireless input device in a wireless fashion.

3. The method of claim 1, wherein the user performs the system configuration setup at the step 3 through a setup interface of the Basic Input/Output System via the wireless input device.

4. The method of claim 1, wherein the computer is rebooted to continue the booting process after the system configuration setup is finished at the step 4.

5. The method of claim 1, wherein the user activates the wireless audio device at the step 5 to make the wireless audio device send an activation signal to the wireless connector to trigger the wireless connector to switch from the first state to the second state.

6. The method of claim 1, Wherein the computer loads an operation system during the booting process at the step 5 to execute an application program related to the wireless connector to trigger the wireless connector to switch from the first state to the second state.

7. The method of claim 1, wherein the wireless input device is selected from the group consisting of a wireless keyboard, a wireless mouse and a wireless remote controller.

8. The method of claim 1, wherein the wireless audio device is selected from the group consisting of a wireless earphone, a wireless speaker and a wireless microphone.

9. The method of claim 1, wherein the wireless connector forms electric connection with the computer through a Universal Serial Bus.

10. The method of claim 1, wherein the wireless connector includes a first USB descriptor at the first state to allow the computer to recognize the wireless connection between the Wireless connector and the wireless input device, and a second USB descriptor at the second state to allow the computer to recognize the wireless connection among the wireless connector and the wireless input device and the wireless audio device.
